(19) United States
(12) Patent Application Publication
(10) Pub. No.: US 2006/0230083 A1
(43) Pub. Date: Oct. 12, 2006

(54) Method and system for profiling and populating a database

(75) Inventors: Gregg R. Allyn, Sammamish, WA (US); Theodore M. Jung, Bellevue, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/102,486

(22) Filed: Apr. 8, 2005

(51) Int. Cl. G06F 17/30

(52) U.S. Cl. 707/204

(57) ABSTRACT

A data generation system includes a profile system and a populate system. The profile system analyzes the data of the database to be profiled to determine characteristics of the data including distribution of data values. A user-specified profile template defines the data to be profiled and how the data is to be profiled. After the profile template is specified, the profile system generates a profile of a profile database as specified by the profile template. The populate system populates a database with data having characteristics that are based on a generated profile. The populate system can thus generate a test database with data that has characteristics that are derived from a profile generated from a production database.

### TECHNICAL FIELD

The described technology relates generally to generating data for a database and particularly to generating test data that has characteristics similar to production data of a database.

### BACKGROUND

Software development is a complex process that typically starts with developing a functional specification that defines the functions of a software product that is to be developed. Software developers then create a design specification for the software that is to implement the defined functions. After the creation of the design specification, software developers, referred to as coders, write and test computer code that implements the software product. Finally, software developers, referred to as testers, perform final testing on the software product to ensure that it correctly implements the functions as defined by the functional specification.

Both the coders and the testers typically prefer to test the software product with data that is representative of the production data that will be used by the software product when it is put into production. For example, if the software product provides customer relationship management (“CRM”) capabilities, then the software product may be tested using the actual production data of a CRM database. The testing of the software product may require acquiring a copy of the CRM database of a company that uses a prior version of the software product and running the newly developed software product against that database. The testing with actual production data helps ensure that problems with the software product that may occur when it is put into production can be discovered and fixed before release of the software product.

Privacy concerns, however, may prevent the use of actual production data when testing a software product. Because of these concerns, the software developers may develop programs to generate and store test data in a test database. To provide an effective testing environment, the generated test data should be an accurate representation of the production data. For example, if each customer record of a CRM database has a minimum of 1 and a maximum of 100 associated contact records with the average being 20 associated contact records, then the test data should have a similar minimum, maximum, and average. Also, if each customer record has associated region records with customer-specific regional identifiers, then the test database should have data that is representative of the regional identifiers. When conducting a stress test on and analyzing performance of the software product, the software developers may want to scale up or down the size of a test database while maintaining the characteristics of production data of that scaled size.

The process of creating test data that accurately represents the characteristics of production data can be time-consuming and expensive. Typically, software developers need to study the production data and then develop computer programs to generate test data with the appropriate characteristics. It would be desirable to have techniques that would help automate the process of generating test data with characteristics that are similar to those of production data.

### SUMMARY

A data generation system includes a profile system and a populate system. The profile system analyzes the data of the database to be profiled (a “profile database”) to determine characteristics of the data including distribution of data values. A user-specified profile template defines the data to be profiled and how the data is to be profiled. After the profile template is specified, the profile system generates a profile of a profile database as specified by the profile template. The generated profile contains various statistics on the profile database as defined by the profile template. The populate system populates a database (a “populate database”) with data having characteristics that are based on a generated profile. To control the populating of the database, a user specifies dimensions for the populate database. The populate system executes the schema-specific population code, which invokes runtime procedures to retrieve profile information and to populate the populate database using those dimensions. The populate system can thus generate a test database with data that has characteristics that are derived from a profile generated from a production database.

### BRIEF DESCRIPTION OF THE DRAWINGS

FIG. 1 is a block diagram that illustrates the components of the profile system of the data generation system in one embodiment.

FIG. 2 is a block diagram that illustrates the components of the populate system of the data generation system in one embodiment.

FIG. 3 is a flow diagram that illustrates the processing of the profiler component of the profile system in one embodiment.

FIG. 4 is a flow diagram that illustrates the processing of the create enumeration histogram component in one embodiment.

FIG. 5 is a flow diagram that illustrates the processing of the create enumeration buckets component of the profile system in one embodiment.

FIG. 6 is a flow diagram that illustrates the processing of the create scenario component of the populate system in one embodiment.

FIG. 7 is a flow diagram that illustrates the processing of the populator component of the populate system in one embodiment.

FIG. 8 is a flow diagram that illustrates the processing of the perform population component of the populate system in one embodiment.

### DETAILED DESCRIPTION

A method and system for generating a profile of data of a database and populating a database based on the generated profile is provided. In one embodiment, the data generation system includes a profile system and a populate system. The profile system analyzes the data of the database to be profiled (a “profile database”) to determine characteristics of the data including distribution of data values. For example, the profile system may analyze a CRM database to determine the average number of contact records per customer record. A user of the profile system generates a profile template that specifies the characteristics of the profile database that are to be profiled. For example, a profile template may specify that one characteristic to be collected is the number of customers with less than 5 contacts, between 5 and 10 contacts, and greater than 10 contacts. The count of the number of customers is thus aggregated into three buckets with the specified ranges. A profile template also defines the data that is to be characterized. The profile template may contain database query code that when executed on the profile database will return the data that is to be used in the characterization. For example, if a user wants to profile customer contacts for only female contacts, then the query would be limited to retrieving contact records for only female contacts. The profile template is thus dependent on the schema of the database being profiled as it contains query code that is specific to the schema. The characteristics of the data to be profiled and the definition of the data to be used in profiling are referred to as a “histogram.” As its name suggests, a histogram defines the buckets of the histogram and the data that is to be bucketized. After a user generates a profile template, the profile system then generates a profile of the profile database by retrieving the defined data and characterizing the retrieved data as specified by each histogram of the profile template. The profile of the database contains the characteristics of the database as defined by the histograms of the profile template. Although the profile template is dependent on the schema of the profile database, the profile component of the profile system that generates a profile is independent of the schema of the profile database. In this way, after a user defines a schema-dependent profile, the profile system can automatically generate the profiles of various instances of databases that follow the schema (e.g., an instance may be the database of a company that uses the software product to be tested).

In one embodiment, the populate system populates a database (a “populate database”) with data having characteristics that are based on a generated profile of a profile database. To control the populating of the database, a user specifies key dimensions for the populate database. For example, the user may specify the number of customer records to be included in the populate database. Although the populate system provides runtime procedures and tables for use in populating the populate database, it uses population code that is developed specifically for the schema of the populate database. When populating a populate database, the populate system initially stores the information of the generated profile in the runtime tables using runtime procedures. After the profile information is stored in the tables, the populate system executes schema-specific code to create procedures and other objects of the populate database. For example, the schema-specific code may create the tables of the populate database to have a specific size. The populate system then executes the schema-specific population code, which invokes the runtime procedures to retrieve profile information from the runtime tables and to populate the populate database. After executing the schema-specific population code, the populate system may execute schema-specific code to clean up temporary procedures, tables, and variables used during the population process. In this way, the populate system can be used to generate a test database with data that has characteristics that are derived from a profile generated from a production database.

Table 1 illustrates an example profile template of the profile system in one embodiment. In this example, the profile template is specified using an XML format. A profile template specifies the histograms that are used to generate a profile for a profile database. The profile template contains one or more histogram elements that each define a histogram that is to be generated as part of the profile. Each histogram has a type that specifies how the data is to be bucketized. The histogram types include enumeration (“enum”), big integer (“bigint”), decimal (“dec”), and date/time (“datetime”). The enumeration type indicates that each bucket corresponds to a discrete string value. For example, a histogram for describing the distribution of time zones may have the buckets of Pacific, Mountain, Central, and Eastern. The big integer type indicates buckets with integer ranges. For example, a histogram for describing distribution of contacts per customer may have buckets with ranges of 1, 2-5, 6-10, and so on. The decimal type is similar to the big integer type except that the ranges can be non-integer. For example, when a database tracks whether sales pitches were successful, the decimal histogram may have buckets of ranges of 0%-25%, 26%-50%, and 51%-100% for counting the success rates of the salespersons. The date/time type is similar to the big integer type except that the ranges have date/time boundaries. For example, a histogram for last time each contact of a customer was called may include buckets with ranges of 2003/01/01-2003/12/31, 2004/01/01-2004/12/31, and so on. The profile template of Table 1 includes two histograms specified on lines 8-41 and 43-59. The “ContactsPerCustomer” histogram of lines 8-41 is a big integer type as indicated by line 8, and the “Variables” histogram of lines 43-59 is an enumeration type as indicated by line 43. The bucket elements of the histograms define the ranges of the buckets of the histogram. The profile template can define the range of each bucket explicitly or can specify that each range be automatically identified. Lines 14-20 define the buckets for the histogram of lines 8-41. The ranges of the buckets are 0-1, 2-5, 6-10, 11-20, and 21 +. The profile template also includes a query for each histogram that defines the data to be used when generating the histogram. The results of the query are value/count pairs that indicate the count of the records of the profile database that have each distinct value. For example, if 5 customers have 1 contact and 6 customers have 3 contacts, then the results will include (1,5) and (3,6) value/count pairs. The profile system generates the histogram from the results and stores the data of the histogram in a profile document. In this example, the (1,5) value/count pair will result in the count of 5 being added to the bucket with the range of 0-1 and the (3,6) value/count pair will result in the count of 6 being added to the bucket with the range of 2-5 when the histogram is generated. In this example, the two histograms have their queries defined by the SQL elements of lines 21-40 and 50-58. The Variables histogram is used to define the size of the profile database for use in scaling the populate database as appropriate. For example, if the profile database has 1,000 customer records with 5,000 contact records, then a populate database with 100 customer records will have 500 contact records.

TABLE 1
Profile Template

| | |
|---|---|
| 1 | <histograms> |

| | |
|---|---|
| 2 | <properties> |

| | |
|---|---|
| 3 | <name>Customer Profile Template</name> |
| 4 | |
| 5 | |

| | |
|---|---|
| 6 | </properties> |
| 7 | |
| 8 | <histogram name=“ContactsPerCustomer” type=“bigint”> |

| | |
|---|---|
| 9 | <properties> |

| 10 | <name></name> |
|---|---|
| 11 | <description>Number of contact records per |
| | customer record </description> |
| 12 | <comments></comments> |

| | |
|---|---|
| 13 | </properties> |
| 14 | <buckets> |

| 15 | <bucket maxValue=“1” minValue=“0” |
|---|---|
| | enumValue=“” bucketIsNull=“false”></bucket> |
| 16 | <bucket maxValue=“5” minValue=“2” |
| | enumValue=“” bucketIsNull=“false”></bucket> |
| 17 | <bucket maxValue=“10” minValue=“6” |
| | enumValue=“” bucketIsNull=“false”></bucket> |
| 18 | <bucket maxValue=“20” minValue=“11” |
| | enumValue=“” bucketIsNull=“false”></bucket> |
| 19 | <bucket maxValue=“” minValue=“21” |
| | enumValue=“” bucketIsNull=“false”></bucket> |

| 20 | </buckets> | |
|---|---|---|
| 21 | <sql>select | |
| 22 | s.Value , | as Value |
| 23 | ,count(*) | as Count |

| | |
|---|---|
| 24 | from ( |

| | |
|---|---|
| 25 | Select |

| | | |
|---|---|---|
| 26 | count(*) | as Value |

| | |
|---|---|
| 27 | from Customer r |
| 28 | join Contact a ON a.Customer_ID = r.ID |
| 29 | group by r.ID |
| 30 | |
| 31 | union all |
| 32 | |
| 33 | |
| 34 | Select |

| | | |
|---|---|---|
| 35 | 0 | as Value |

| | |
|---|---|
| 36 | from Customer r |
| 37 | left join Contact a ON a.Customer_ID = r.ID |
| 38 | where a.Customer_ID is null |

| | |
|---|---|
| 39 | ) s |
| 40 | group by s.Value</sql> |

| | |
|---|---|
| 41 | </histogram> |
| 42 | |
| 43 | <histogram name=“Variables” type=“enum”> |

| | |
|---|---|
| 44 | <properties> |

| 45 | <name></name> |
|---|---|
| 46 | <description>These values are meant to assist in |
| | assigning realistic values to variables in |

the scenario document.</description>

47

| | |
|---|---|
| 48 | </properties> |
| 49 | <buckets></buckets> |
| 50 | <sql>select |
| 51 | null as [Value] |
| 52 | ,null as [Count] |

| | |
|---|---|
| 53 | where 1 = 0 |
| 54 | union all |
| 55 | select |

| | |
|---|---|
| 56 | ‘NumberOfCustomerRecords’ |
| 57 | ,count(*) |

| | |
|---|---|
| 58 | from Customer</sql> |

| | |
|---|---|
| 59 | </histogram> |

| | |
|---|---|
| 60 | </histograms> |

Table 2 illustrates a profile generated using the profile template of Table 1. A profile contains histogram elements corresponding to the histogram elements of the profile template used to generate the profile. Lines 13-53 correspond to the histogram of lines 8-41 of Table 1. The bucket elements of lines 48-52 contain the histogram data. For example, the bucket element of line 48 indicates that the bucket with a range of 0-1 contains a count of 2 and accounts for 8.3% of the customers, and the bucket element of line 49 indicates that the bucket with the range of 2-5 contains a count of 11 and accounts for 45.8% of the customers. Line 13 indicates that the minimum value of contacts per customer is 1 and the maximum value of contacts per customer is 43. Lines 14-42 specify that the stored procedure named “CreateBigintHistogram” was invoked to generate the data of the histogram passing the parameters defined by lines 15-34 and lines 35-42. Lines 15-34 correspond to the actual parameter that was passed as the query to the stored procedure, and lines 35-42 correspond to the actual parameter that was passed as the bucket ranges to the stored procedure.

TABLE 2
Profile

| | |
|---|---|
| 1 | <histograms> |
| 2 | |

| | |
|---|---|
| 3 | <properties> |

| | |
|---|---|
| 4 | <name>ContactsPerCustomerProfile</name> |
| 5 | |
| 6 | |

| | |
|---|---|
| 7 | </properties> |
| 8 | <generationProperties> |

| | |
|---|---|
| 9 | <profileTemplatePath>Table 1</profileTemplatePath> |
| 10 | <dataSource> NameOfProfileDatabase<dataSource /> |

| 11 | </generationProperties> |
|---|---|
| 12 | |
| 13 | <histogram name=“ContactsPerCustomer” type=“bigint” |
| | minValue=“1” maxValue=“43” |

| | |
|---|---|
| 14 | #CreateBigIntHistogram |
| 15 | @QueryText = ‘select |

| | | |
|---|---|---|
| 16 | s.Value | as Value |
| 17 | ,count(*) | as Count |

| | |
|---|---|
| 18 | from ( |

| | |
|---|---|
| 19 | select |

| | | |
|---|---|---|
| 20 | count(*) | as Value |

| | |
|---|---|
| 21 | from Customer r |
| 22 | join Contact a ON a.Customer_ID = r.ID |
| 23 | group by r.ID |
| 24 | |
| 25 | union all |
| 26 | |
| 27 | |
| 28 | select |

| | | |
|---|---|---|
| 29 | 0 | as Value |

| | |
|---|---|
| 30 | from Test r |
| 31 | left join Contact a ON a.Customer_ID = r.ID |
| 32 | where a.Customer_ID is null |

| | |
|---|---|
| 33 | ) s |
| 34 | group by s.Value’ |
| 35 | ,@BucketXml = |
| 36 | ‘<buckets> |

| | |
|---|---|
| 37 | <bucket minValue=“0” maxValue=“1” bucketIsNull=“0” /> |
| 38 | <bucket minValue=“2” maxValue=“5” bucketIsNull=“0” /> |
| 39 | <bucket minValue=“6” maxValue=“10” bucketIsNull=“0” /> |
| 40 | <bucket minValue=“11” maxValue=“20” bucketIsNull=“0” /> |
| 41 | <bucket minValue=“21” maxValue=“” bucketIsNull=“0” /> |

| | |
|---|---|
| 42 | </buckets>’ |
| 43 | |
| 44 | <properties> |

| | |
|---|---|
| 45 | <description>ContactsPerCustomer</description> |
| 46 | <comments></comments> |

| 47 | </properties> |
|---|---|
| 48 | <bucket percentage=“8.3” actualCount=“2” bucketIsNull=“false” |
| | enumValue=“0 - 1” |
| | minValue=“0” maxValue=“1”/> |
| 49 | <bucket percentage=“45.8” actualCount=“11” bucketIsNull=“false” |
| | enumValue=“2 - 5” |
| | minValue=“2” maxValue=“5” /> |
| 50 | <bucket percentage=“20.8” actualCount=“5” bucketIsNull=“false” |
| | enumValue=“6 - 10” |
| | minValue=“6” maxValue=“10”/> |
| 51 | <bucket percentage=“8.3” actualCount=“2” bucketIsNull=“false” |
| | enumValue=“11 - 20” |
| | minValue=“11” maxValue=“20” /> |
| 52 | <bucket percentage=“16.7” actualCount=“4” bucketIsNull=“false” |
| | enumValue=“21 - 43” |
| | minValue=“21” maxValue=“43” /> |
| 53 | </histogram> |
| 54 | |
| 55 | <histogram name=“Variables” type=“enum” > |
| 56 | #CreateEnumHistogram |
| 57 | @QueryText = ‘select |

| | |
|---|---|
| 58 | null as [Value] |
| 59 | ,null as [Count] |

| | |
|---|---|
| 60 | where 1 = 0 |
| 61 | union all |
| 62 | select |

| | |
|---|---|
| 63 | ‘NumberOfCustomerRecords’ |
| 64 | ,count(*) |

| | |
|---|---|
| 65 | from Test’ |
| 66 | ,@BucketXml = ” |

Table 3 contains an example of a stored procedure that is used for generating the data of a histogram of an enumeration type. Each type of the histogram has an analogous stored procedure. In particular, the profile system includes a stored procedure for the big integer, decimal, and date/time types. The stored procedures are database schema independent and are passed two parameters that are schema dependent. The parameters are the query and the bucket ranges of the histogram. The stored procedures contain the SQL code for generating the data of a histogram defined in a profile template. The stored procedure for the enumeration histogram allows the ranges of the buckets to be specified in the profile template or to be automatically generated. The stored procedure creates a query results table that contains the value/count pairs as indicated by lines 13-16. The stored procedure then executes the query of the histogram as indicated by lines 18-23. In lines 25-40, the stored procedure automatically identifies the enumerations when the bucket parameter is null. In lines 40-73, the stored procedure calculates the values for the buckets and stores the count for each value in the profile. In lines 48-59, the stored procedure retrieves enumerations from the profile template. In lines 62-73, the stored procedure counts the records that match each enumeration.

TABLE 3
Profile Procedures

| | |
|---|---|
| 1 | exec(‘create proc #CreateEnumHistogram |

| 2 | @QueryText | nvarchar(4000) | |
|---|---|---|---|
| 3 | ,@BucketXml | ntext | = null |

| | |
|---|---|
| 4 | as’) |

| | |
|---|---|
| 5 | go |
| 6 | |
| 7 | alter proc #CreateEnumHistogram |

| 8 | @QueryText | nvarchar(4000) | |
|---|---|---|---|
| 9 | ,@BucketXml | ntext | = null |
| 10 | | | |

| | |
|---|---|
| 11 | as |
| 12 | |
| 13 | create table #EnumQueryResults ( |

| | | |
|---|---|---|
| 14 | [Value] | nvarchar(1000) |
| 15 | ,[Count] | int |

| | |
|---|---|
| 16 | ) |
| 17 | |
| 18 | insert into #EnumQueryResults |
| 19 | exec (@QueryText) |
| 20 | |
| 21 | |
| 22 | declare @TotalValues int |
| 23 | select @TotalValues = sum(Count) from #EnumQueryResults |
| 24 | |
| 25 | if (@BucketXml is null) |
| 26 | begin |

| | |
|---|---|
| 27 | select |

| | | |
|---|---|---|
| 28 | isnull([Value], ”) | as EnumValue |
| 29 | ,sum(Count) | as ActualCount |

| | |
|---|---|
| 30 | ,case |

| | |
|---|---|
| 31 | when [Value] is null then cast(1 as bit) |
| 32 | else cast(0 as bit) |

| | | |
|---|---|---|
| 33 | end | as BucketIsNull |

| 34 | ,cast ((convert(float, sum(Count)) / @TotalValues * |
|---|---|
| | 100) as float) as Percentage |

| | |
|---|---|
| 35 | from #EnumQueryResults |
| 36 | group by [Value] |
| 37 | order by 1 |
| 38 | |
| 39 | goto SelectSecondTable |

| | |
|---|---|
| 40 | end |
| 41 | |
| 42 | create table #Bucket ( |

| | | | |
|---|---|---|---|
| 43 | BucketID | int | identity(1,1) primary key |

| | | |
|---|---|---|
| 44 | ,EnumValue | nvarchar(1000) |

| | |
|---|---|
| 45 | ,BucketIsNull bit |

| | |
|---|---|
| 46 | ) |
| 47 | |
| 48 | declare @idoc int |
| 49 | exec sp_xml_preparedocument @idoc OUTPUT, @BucketXml |
| 50 | |
| 51 | INSERT INTO #Bucket (EnumValue, BucketIsNull) |
| 52 | SELECT * |
| 53 | FROM OPENXML (@idoc, ‘//bucket’) |

| | |
|---|---|
| 54 | WITH ( |

| | | | |
|---|---|---|---|
| 55 | EnumValue | nvarchar(1000) | ‘@enumValue’ |

| | | |
|---|---|---|
| 56 | ,BucketIsNull bit | ‘@bucketIsNull’ |

| | |
|---|---|
| 57 | ) |
| 58 | |

| | |
|---|---|
| 59 | EXEC sp_xml_removedocument @idoc |
| 60 | |
| 61 | |
| 62 | select |

| | | |
|---|---|---|
| 63 | isnull(b.EnumValue, ”) | as EnumValue |
| 64 | ,isnull(sum(qr.Count), 0) | as ActualCount |

| | | |
|---|---|---|
| 65 | ,b.BucketIsNull | as BucketIsNull |

| 66 | ,isnull(cast ((convert(float, sum(qr.Count)) / |
|---|---|
| | @TotalValues * 100) as float), 0) as |

| | Percentage |
|---|---|
| 67 | from #Bucket b |
| 68 | left join #EnumQueryResults qr ON |

| | |
|---|---|
| 69 | (qr.[Value] = b.EnumValue AND b.BucketIsNull = 0) |
| 70 | OR |
| 71 | (qr.[Value] is null AND b.BucketIsNull = 1) |

| | |
|---|---|
| 72 | group by b.EnumValue, b.BucketIsNull |
| 73 | order by 1 |
| 74 | |
| 75 | SelectSecondTable: |
| 76 | select |

| | | |
|---|---|---|
| 77 | 0 | as MinValue |
| 78 | ,0 | as MaxValue |
| 79 | | |

| | |
|---|---|
| 80 | ExitFromModule: |

Table 4 illustrates a scenario for populating a database using the specified profile and variables. Lines 2-15 define the scenario. The configuration element of lines 7-11 identify the profile and the name for the populate database. The variable of line 13 specifies that the populate database is to include 10 customer records.

TABLE 4
Scenario

1

| | |
|---|---|
| 2 | <scenario name=“Scenario Example - Test1” type=“Test”> |
| 3 | |
| 4 | |
| 5 | |
| 6 | |
| 7 | <configuration> |

| | |
|---|---|
| 8 | <profileDocumentPath>Table2/profileDocumentPath> |
| 9 | |
| 10 | <databaseName>PopulateDatabase</databaseName> |

| | |
|---|---|
| 11 | </configuration> |
| 12 | <variables> |

| | |
|---|---|
| 13 | <variable name=“NumberOfCustomerRecords”>10</variable> |

| | |
|---|---|
| 14 | </variables> |
| 15 | </scenario> |

Table 5 lists the components of the populate system in one embodiment along with their descriptions.

TABLE 5
Populate System Components

| Component | Description |
|---|---|
| PopulatorMain | Main component of the populate system. |
| | It performs the following steps: |
| | 1. Reads in scenario and profile documents. |
| | 2. Reads the Populator configuration file. |
| | 3. Executes SQL scripts on the populate |
| | database to create runtime objects. |
| | 4. Executes procedures to insert profile |
| | and scenario data into runtime |
| | objects in the populate database. |
| | 5. Executes population procedures. |
| | 6. Displays database messages as returned |
| | from the populate database. |
| Populator configuration | XML document that contains mappings of |
| file | database types and versions to sets of |
| | runtime object setup scripts, database-type |
| | specific scripts, and cleanup scripts. |
| Script setup files | XML documents that contain a list of |
| | directories whose .sql files should |
| | be executed against the populate database. |
| Runtime object scripts | SQL scripts used to create tables, functions, |
| | and stored procedures to hold profile and |
| | scenario data, and access them. |
| Runtime objects | The actual database objects created by the |
| | runtime object scripts. These objects hold |
| | histogram and variable data, manage population |
| | instance data and state, provide interface |
| | into histogram and variable data, and validate |
| | that the runtime is intact. |
| Population object | SQL scripts to create procedures and other |
| scripts | objects concerned with the specifics of |
| | populating a particular type of database. |
| Population objects | The actual database objects used to |
| | perform population. |
| Cleanup scripts | Drops all objects created by the runtime |
| | object scripts. |

Table 6 lists the runtime objects—tables and stored procedures—used to populate the populate database. The stored procedures are invoked by the populator component.

TABLE 6
Runtime Objects

| Object | Description |
|---|---|
| Histogram | A table that contains all histogram data. |
| LoadHistograms | A procedure that allows Populator to move an |
| | entire profile into the database at once. The |
| | Histogram table is populated by this procedure. |
| Variable | A table that contains all variable data (from the scenario document). |
| LoadVariables | A procedure that allows Populator to move all the variable data in |
| | the scenario document into the Variable table. |
| GetVersion | A procedure that gets the current populator code version and revision date. |
| SetVersion | A procedure that sets the current populator code version and revision date. |
| ValidateObjects | A procedure that validates that all inventoried objects are present. Also, |
| | calls ValidateRuntimeObjects and thepopulation code method ValidatePopulationCode. |
| ValidateRuntimeObjects | A procedure that performs additional checks on the runtime, |
| | such as whether domain tables are properly populated. |
| Purge | A procedure that calls the population code method Purge. After the population |
| | code has performed its purging, this procedure then purges all Histogram and |
| | Variable data. |
| CV_ConfigVariable | A table that stores configuration variables. |
| CV_SetConfigVariable | A procedure that sets a config variable. |
| CV_GetConfigVariable | A scalar function that returns the current value of a config variable. |
| GetHistogramValueEnum | A user-defined function that returns an enum value as an nvarchar |
| | for the given histogram. |
| GetHistogramValueBigInt | A user-defined function that returns a bigint for the given histogram. |
| GetHistogramValueBigIntWithRange | A user-defined function that returns a bigint for the given histogram, |
| | using a range other than the range of data in the original source data. |
| GetHistogramValueDecimal | A user-defined function that returns a decimal for the given histogram. |
| GetHistogramValueDecimalWithRange | A user-defined function that returns a decimal for the given histogram, |
| | using a user-specified range. |
| GetHistogramValueDateTime | A user-defined function that returns a datetime for the given histogram. |
| GetHistogramValueDateTimeWithRange | A user-defined function that returns a datetime for the given histogram, |
| | using a user-specified range. |
| GetEnumeratedValuesFromHistogram | A table-valued function that returns a one-column list of all the |
| | enumerated values for a histogram of type enum. |
| GetHistogramRange | A table-valued function that returns a one-row table showing the min and |
| | max values for the given non-enum histograms. |
| HistogramExists | A scalar function that returns a value indicating whether the specified |
| | histogram exists of the given type. |
| VariableExists | A scalar function that returns a value indicating whether the specified |
| | variable exists. |
| GenerateRandomCharacterString | A stored procedure that returns a random character string of the given length. |
| GenerateRandomEmailAddress | A stored procedure that returns a random email address of the given length, |
| | with the given domain name. If no domain name is specified, one is randomly |
| | chosen. |
| GetVariable | A user-defined function that returns the value for the variable specified |
| | as an nvarchar. |

Table 7 illustrates a script for populating a populate database in one embodiment. The script creates the customer table and adds a specified number of records and then creates a contact table and adds a specified number of records.

TABLE 7
Populating Script

declare @ContactFirstName nvarchar(256)
declare @CustomersToCreate int
set @CustomersToCreate = dbo.GetVariable(‘NumberofCustomers’)
declare @ContactsThisCustomers int
while @loopToCreateCustomers < @CustomersToCreate
begin
insert into Customers
(
Customers_Key
,Locale
,Default_Time_Zone
)
values
(
‘customers_key_’ + convert(nvarchar, @loopToCreateCustomers)
,dbo.GetHistogramValueEnum(‘locale’)
,dbo.GetHistogramValueEnum(‘time zone’)
)
select ®curCustomersID = SCOPE_IDENTITY( )
set @loopToCreateContacts = 0
set @ContactsThisCustomers =
dbo.GetHistogramValueInt(‘contacts per customers’)
while @loopToCreateContacts < @ContactsThisCustomers
begin

exec GenerateRandomCharacterString

@Length = dbo.GetHistogramValueInt(‘name length’)
,@ContactFirstName OUTPUT

insert into Membership
(
Customers_ID
,Contact_ID
,First_Name
)
values
(
@curCustomersID
,‘contact_id_’ + convert(nvarchar, @loopToCreateContacts)
,@ContactFirstName
)
end
end

Table 8 lists stored procedures that are specific to the schema of the populate database. These stored procedures are called the populator component when populating the populate database.

TABLE 8
Stored Procedures

| Functional Unit | |
|---|---|
| (Stored Procedure) | Description |
| ValidatePopulationObjects | This stored procedure is called |
| | indirectly by Populator.exe before |
| | running Populate. Its purpose is |
| | to validate that objects necessary |
| | for this population run are |
| | present. |
| ValidatePopulationData | This stored procedure is called by |
| | Populate as the first step in a |
| | population run. It verifies that |
| | expected histograms and variables |
| | are present and within expected |
| | ranges. |
| Populate | Primary driver stored procedure |
| | for the schema-specific process. |
| | Populate calls numerous other |
| | Runtime and schema-specific stored |
| | procedures in order to do its work. |
| PopulateCustomer | This stored procedure handles |
| | creating customer records. |
| | Logic: |
| | loop {variable: |
| | NumberOfCustomerRecords} times |
| | begin |

insert record into Customer
call PopulateContact, passing
the ID of the newly created

| | Customer record. |
|---|---|
| | End |
| PopulateContact | This stored procedure creates the |
| | Contact records for the given |
| | Customer record. |
| | Logic: |
| | get histogram value |
| | {ContactsPerCustomerInstance} |
| | loop |
| | {ContactsPerCustomerInstance} |
| | times |
| | begin |

insert record into Contact

end

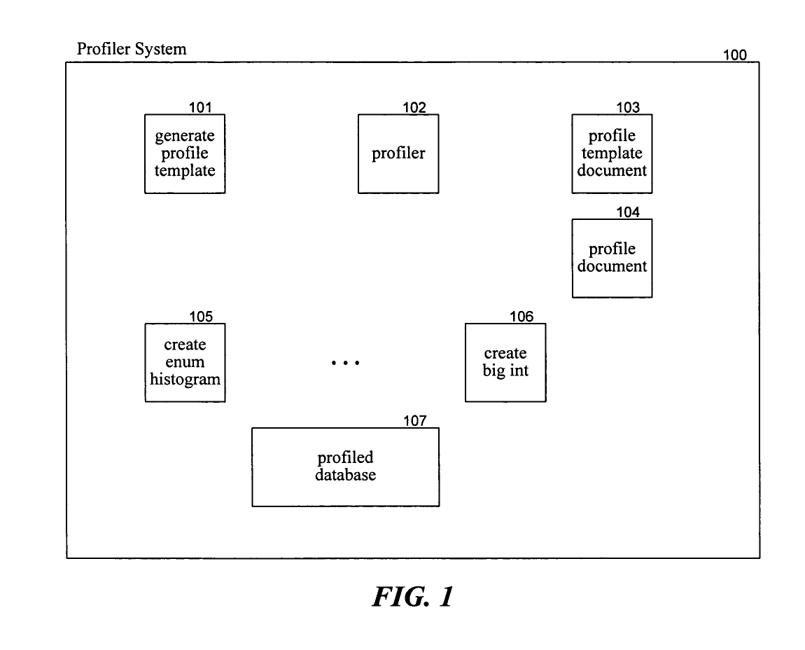

FIG. 1 is a block diagram that illustrates the components of the profile system of the data generation system in one embodiment. The profile system 100 includes a generate profile template component 101, a profiler component 102, and various auxiliary components, such as a create enumeration histogram component 105 and a create big integer component 106. The generate profile template component generates a profile template document 103 in response to user input. The profiler component inputs the profile template document and generates a profile document 104 based on a profile database 107. The profiler component invokes the various auxiliary components when generating the profile document.

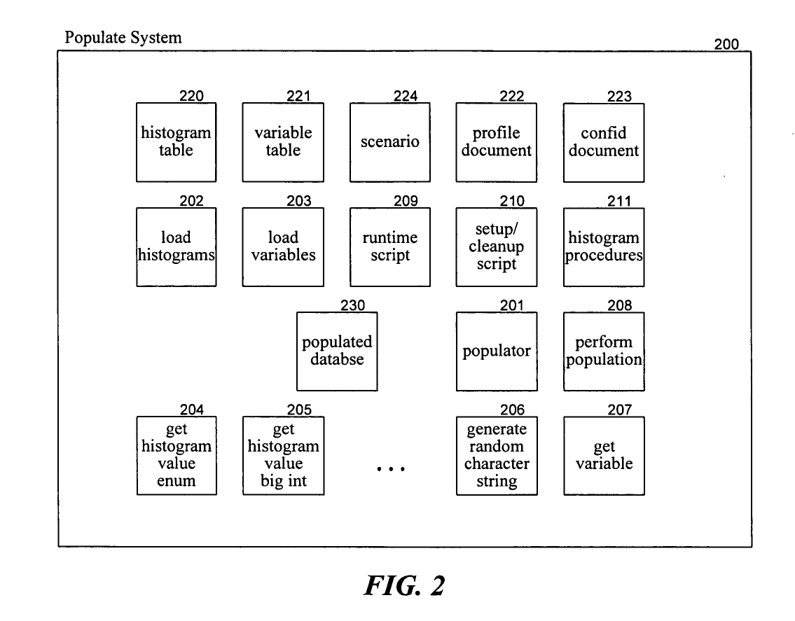

FIG. 2 is a block diagram that illustrates the components of the populate system of the data generation system in one embodiment. The populate system 200 includes a populator component 201, a load histograms component 202, a load variables component 203, and auxiliary components, such as a get histogram value enumeration component 204, a get histogram value big integer component 205, a generate random character string component 206, and a get variable component 207. Components 201-207 are independent of the schema of the database to be populated. The populate system also includes schema-dependent components such as a perform population component 208, a runtime script 209, setup/cleanup scripts 210, and histogram procedures 211. The populate system also includes a histogram table 220, a variable table 221, a profile document 222, a configuration document 223, and a scenario document 224. In operation, the populator component creates the histogram table and variable table, which are used to hold the histograms and variables of the profile document. The populator component then invokes the load histograms component and the load variables component to load the histogram table and the variables table from the profile document. The populator component also executes the schema-specific setup/cleanup and runtime scripts. The populator component invokes the perform population component to populate the database based on the profile data. The perform population component invokes schema-specific components and auxiliary components to populate the database based on the data of the histogram table and the variable table.

The computing devices on which the data generation system is implemented may include a central processing unit, memory, input devices (e.g., keyboard and pointing devices), output devices (e.g., display devices), and storage devices (e.g., disk drives). The memory and storage devices are computer-readable media that may contain instructions that implement the data generation system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the data generation system may be implemented in various operating environments that include personal computers, server computers, hand-held or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The data generation system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

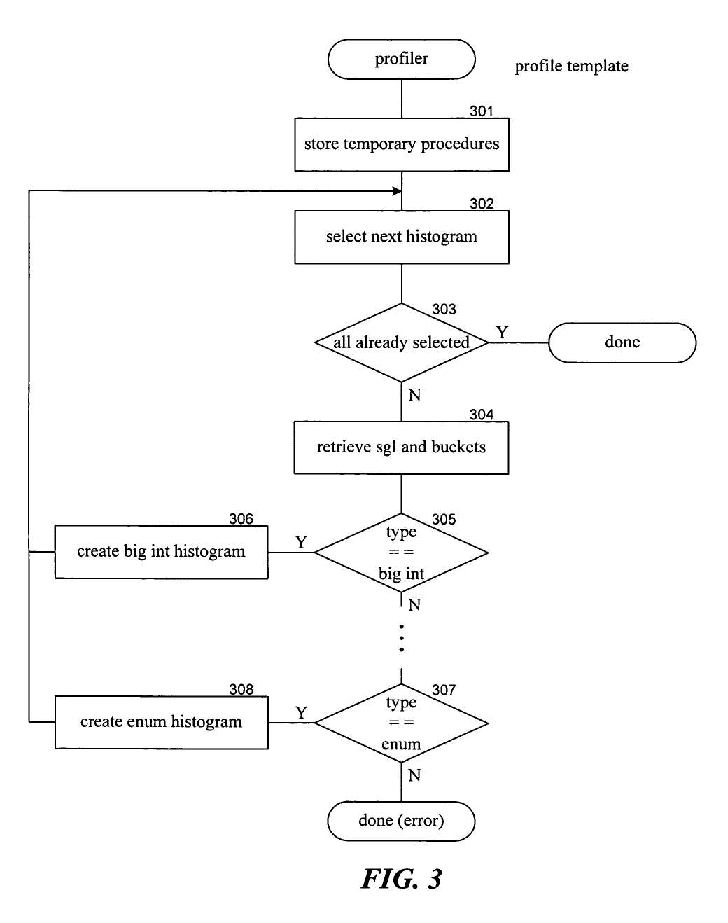

FIG. 3 is a flow diagram that illustrates the processing of the profiler component of the profile system in one embodiment. The component inputs a profile template and generates a profile of the profile database. In block 301, the component stores the profile procedures, such as “CreateBigintHistogram,” in the profile database. In blocks 302-308, the component loops generating the profile data for each histogram of the profile template. In block 302, the component selects the next histogram. In decision block 303, if all the histograms have already been selected, then the component completes, else the component continues at block 304. In block 304, the component retrieves the SQL element and the bucket elements for the selected histogram. The data of these elements are used as parameters for generating the data of the histogram. In blocks 305-308, the component executes the appropriate stored procedure based on the type of the histogram. For example, in decision block 305, if the histogram is a big integer type, then the component invokes the create big integer histogram component in block 306. In decision block 307, if the histogram is an enumeration type, then the component invokes the create enumeration histogram component in block 308. The component then loops to block 302 to select the next histogram.

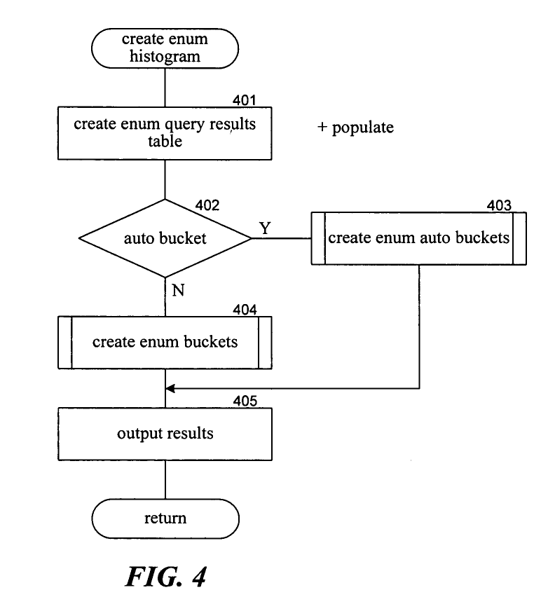

FIG. 4 is a flow diagram that illustrates the processing of the create enumeration histogram component in one embodiment. The component generates the data for an enumeration histogram. In block 401, the component creates an enumeration query results table that includes value/count pairs. The component then executes the query of the histogram to generate the data for the table. In decision block 402, if auto bucketing is used, then the component continues at block 403, else the component continues at block 404. In block 403, the component invokes a create enumeration auto buckets component to create a bucket for each distinct value in the enumeration query results table and to determine the counts for the buckets. In block 404, the component invokes a create enumeration buckets component to create the buckets as specified in the bucket elements of the histogram and to determine the counts for the buckets. In block 405, the component then outputs the bucket results and then returns.

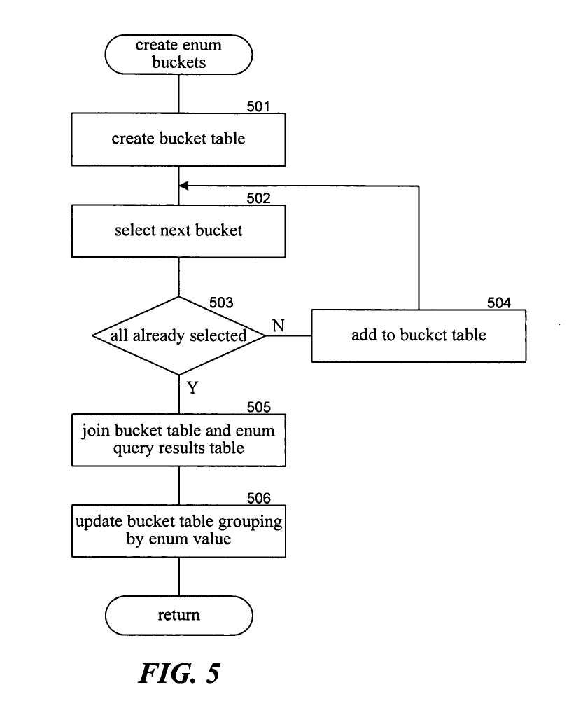

FIG. 5 is a flow diagram that illustrates the processing of the create enumeration buckets component of the profile system in one embodiment. The component generates a bucket table containing an entry for each enumeration along with the value of the enumeration. The component then uses SQL joins with the profile database to generate the data for the bucket table. In block 501, the component creates the bucket table. In blocks 502-504, the component loops adding an entry to the table for each bucket. In block 502, the component selects the next bucket. In decision block 503, if all the buckets have already been selected, then the component continues at block 505, else the component continues at block 504. In block 504, the component adds a record to the table for the selected bucket and then loops to block 503 to select the next bucket. In block 505, the component performs the joining of the bucket table and the enumeration query results table needed to generate the data for the bucket table. In block 506, the component then executes an SQL statement on the join to update the bucket table grouping by enumeration value. The component then returns.

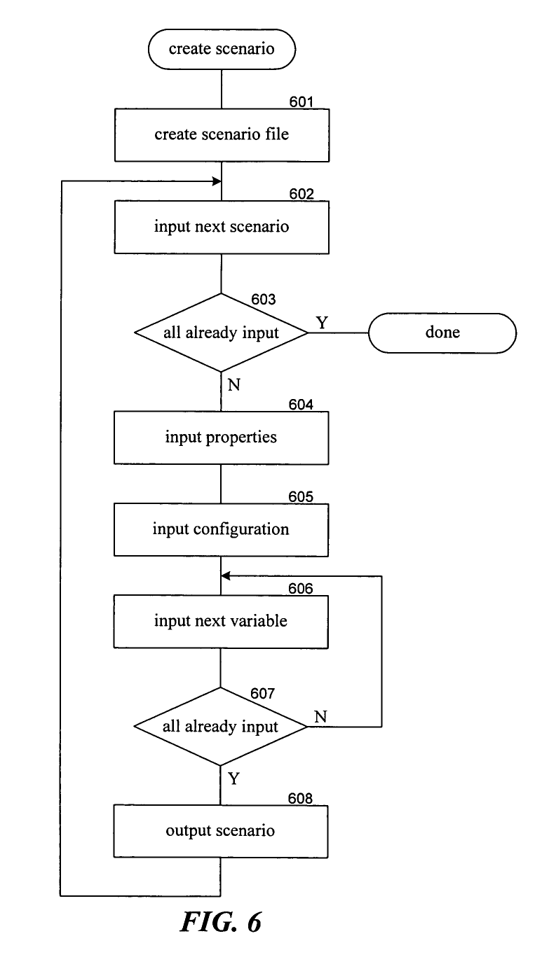

FIG. 6 is a flow diagram that illustrates the processing of a create scenario component of the populate system in one embodiment. A scenario document may have multiple scenarios with each scenario having properties, configuration information, and variable information. When the populator component is executed, it is passed a scenario document identifying a scenario within the document. The populator component then populates the database based on the identified scenario. In block 601, the component creates the scenario document. In blocks 602-608, the component loops creating scenarios. In block 602, the component inputs an indication that a next scenario is to be created. In decision block 603, if all the scenarios have already been created, then the component completes, else the component continues at block 604. In block 604, the component inputs properties from the user. In block 605, the component inputs configuration information from the user such as the name of the profile document and the name for the populate database. In blocks 606-607, the component loops inputting variable information. In block 606, the component inputs an indication that the user wants to input another variable. In decision block 607, if all the variables have already been input, then the component continues at block 608, else the component loops to block 606 to select the next variable. In block 608, the component outputs the scenario to the scenario document and then loops to block 602 to process the next scenario.

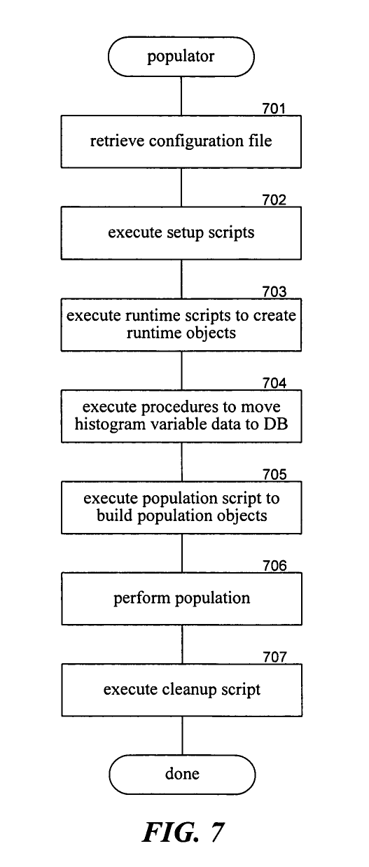

FIG. 7 is a flow diagram that illustrates the processing of the populator component of the populate system in one embodiment. The component is passed a scenario and populates the populate database based on the information of the scenario. In block 701, the component retrieves the configuration file. In block 702, the component executes the setup scripts. In block 703, the component executes the runtime scripts to create the runtime objects. In block 704, the component executes procedures to move the histogram data and variable data to the populate database. In block 705, the component executes the population script to build the population objects. In block 706, the component invokes the perform population component to populate the populate database. In block 707, the component executes the cleanup scripts and then completes.

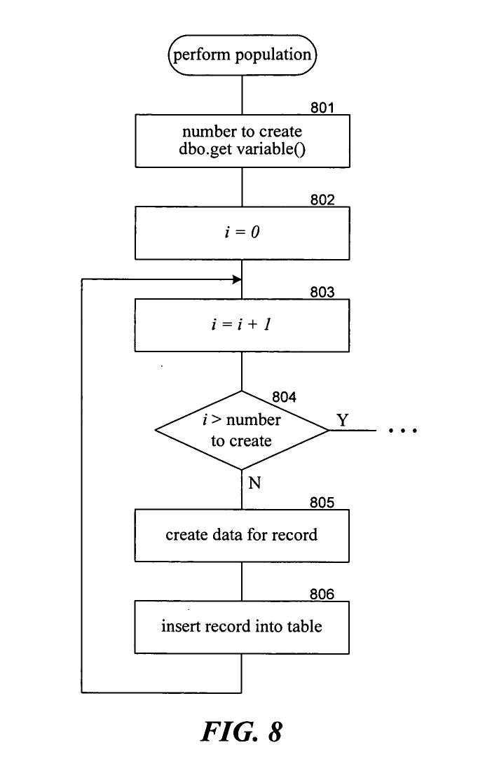

FIG. 8 is a flow diagram that illustrates the processing of the perform population component of the populate system in one embodiment. The component is schema-specific and is developed separately for each database to be populated. In block 801, the component retrieves the number of records to create from the number of customer records variable. In blocks 802-808, the component loops creating the customer records. In block 802, the component initializes a counter for tracking the number of customer records. In block 803, the component increments the counter for the next customer record. In decision block 804, if the specified number of customer records has already been created, then the component continues to populate the next table (e.g., a contact table), else the component continues at block 805. In block 805, the component creates the data for the record. For example, the component may invoke the generate random character string component to generate a random string for a customer name. In block 806, the component inserts the record for the customer into the customer table and then loops to block 803 to process the next customer record.

From the foregoing, it will be appreciated that specific embodiments of the data generation system have been described herein for purposes of illustration, but that various modifications may be made without deviating from the spirit and scope of the invention. One skilled in the art will appreciate that the profile system can be used to create a profile for any database. The information of the profile can be used to optimize the database configuration, to analyze overall characteristics of the database (e.g., average number of contacts per customer), to analyze trends (e.g., day-to-day profiles), and so on. The information of a profile can also be presented graphically to assist in the analysis. Accordingly, the invention is not limited except as by the appended claims.

I/We claim:

1. A computer system for generating a profile of a database having a schema, comprising:
a profile template that specifies data of the database that is to be profiled and defines aggregations for the data that is to be profiled; and
a profiler component that generates a profile of the database by querying the database to retrieve the specified data; and
aggregating the retrieved data according to the defined aggregations wherein the profiler component is independent of the schema of the database that is profiled.

2. The computer system of claim 1 wherein the profile template specifies the data of the database to be profiled by specifying queries for the data.

3. The computer system of claim 2 wherein the queries are specified using a structured query language.

4. The computer system of claim 1 wherein a profile represents a distribution of data of the database.

5. The computer system of claim 1 wherein the aggregations represent ranges of data values for accumulating a count of data of the database within the range.

6. The computer system of claim 1 including a population component that populates a database with data based on the generated profile.

7. The computer system of claim 6 wherein the populated database has a distribution of data values that is based on the generated profile.

8. The computer system of claim 1 wherein the profiler component generates profiles of databases with different schemas.

9. A computer-readable medium containing a data structure comprising a plurality of histograms, each histogram defining data value ranges for aggregating data of a database that is to be profiled and specifying data of the database that is to be aggregated.

10. The computer-readable medium of claim 9 wherein the specification of the data that is to be aggregated includes queries for the data.

11. The computer-readable medium of claim 10 wherein the queries are specified using a structured query language.

12. The computer-readable medium of claim 9 wherein the data structure is represented using an extensible markup language.

13. The computer-readable medium of claim 9 wherein a profile of a database represents a distribution of data of the database.

14. The computer-readable medium of claim 9 wherein the data value ranges are for accumulating counts of data of the database within the range.

15. The computer-readable medium of claim 9 wherein a profile of a database represents a distribution of data of the database, wherein the data structure is represented using an extensible markup language, wherein the specification of the data that is to be aggregated includes queries for the data that are specified using a structured query language, and wherein the ranges of data values are for accumulating counts of data of the database within the range.

16. A method in a computer system for populating a populate database to have a distribution of data values that is based on the distribution of data values of a profile database, the method comprising:
providing a specification that defines data of the profile database that is to provide the distribution for the populate database and defines data value ranges of the distribution;
querying the profile database to retrieve the defined data;
accumulating counts of the retrieved data according to the defined data value ranges; and
adding data to the populate database based on distribution of the accumulated counts.

17. The method of claim 16 wherein the specification specifies the data of the profile database by specifying queries for the data.

18. The method of claim 16 including storing the accumulated counts in a profile document.

19. The method of claim 16 wherein the definition of the data value ranges indicates that a separate range is to be defined for each distinct data value.

20. The method of claim 16 including creating the populate database.
